(19) United States
(12) Patent Application Publication
(10) Pub. No.: US 2020/0320554 A1
(43) Pub. Date: Oct. 8, 2020

(54) METHOD FOR PREDICTING FUTURE SELLER PRODUCT VALUES FOR DETERMINING INVESTOR CAPITAL CONTRIBUTIONS

(71) Applicant: AccrueMe LLC, Pearl River, NY (US)

(72) Inventors: Eric Kotch, Tappan, NY (US); Donald Henig, West Islip, NY (US)

(21) Appl. No.: 16/841,591

(22) Filed: Apr. 6, 2020

Related U.S. Application Data
(60) Provisional application No. 62/829,181, filed on Apr. 4, 2019.

(51) Int. Cl. G06Q 30/02; G06Q 10/08

(52) U.S. Cl. CPC G06Q 30/0202; G06Q 10/08; G06Q 30/0201

(57) ABSTRACT

The present disclosure provides a system and method for predicting a future seller inventory values used to determine qualified capital contributions to be made by investors at desired points in time. The method involves retrieving seller information and seller product data from a retail logistic provider database. The seller product data is classified into one or more categories to determine seller products that are accepted for predicting the future seller inventory values. Future product sales and pricing of each seller product within the product inventory over a predefined time period are predicted by the system. With the predicted future product sales and pricing, a future seller inventory value for each accepted seller product and a future total seller inventory value over the predetermined time period can be determined. With the future seller inventory value for each accepted seller product and the future total seller inventory value known, a qualified capital contribution amount can be calculated.

### CROSS-REFERENCE TO RELATED APPLICATIONS

The present disclosure is based on and claims benefit from co-pending U.S. Provisional Patent Application Ser. No. 62/829,181 filed on Apr. 4, 2019 entitled “An Efficient Method and System for Facilitating and Managing Growth Capital Investment” the contents of which are incorporated herein in their entirety by reference.

### BACKGROUND

### Field

The present disclosure relates generally to systems and methods for predicting future seller product values used to determine investor capital contributions to early stage companies involved in multiple small sales transactions using an online retail logistic provider.

### Description of the Related Art

Equity financing generally requires complex and expensive underwriting and is generally not available to early stage companies. In instances where equity financing is available to early stage companies, the investor typically retains a significant equity stake in the early stage company for a long term, all or nothing payback. Debt financing for early stage companies, when available, also involves complex and expensive underwriting that require regular payments which inhibit the growth of early stage companies.

Existing equity and debt financing solutions for early stage companies generally cannot accommodate or do not permit unilateral capital structure adjustments by the early stage company. Additionally, existing equity and debt financing solutions generally cannot provide automated real-time underwriting and funding that is cost effective for such early stage businesses.

### SUMMARY

The present disclosure provides a system and method that enables early stage companies involved in multiple small sales transactions using an online retail logistic provider, to manage growth capital by predicting in real-time a monetary value of the seller's future sales products being sold by the online retail logistic provider. The predictive system permits an owner of such an early stage company to make real-time changes to repayment terms, capital structure and transaction decisions in their business while simultaneously providing high returns and capital protections to inventors. Using the predictive system and method according to the present disclosure results in no fixed repayment terms, gives up no permanent equity, and causes the investor profit share percentage to dissipate over time returning full equity back to the owners of the early stage company.\

In an exemplary embodiment, a method for predicting a future seller product value for determining qualified capital contributions at desired points in time includes retrieving seller information and seller product data from a retail logistic provider database, predicting future product sales and pricing of each seller product within the retrieved seller product data over a predefined time period, classifying each seller product in the seller product data into one or more categories to determine an accepted seller product inventory, determining a future seller product value for each seller product in the accepted seller product inventory over the predetermined time period, assigning one or more seller products in the accepted seller product inventory into an investment product pool, and calculating a qualified capital contribution amount and schedule for the seller based upon the future seller product inventory value for each seller product in the investment product pool over the predetermined time period.

### BRIEF DESCRIPTION OF THE DRAWINGS

The figures depict embodiments for purposes of illustration only. One skilled in the art will readily recognize from the following description that alternative embodiments of the structures illustrated herein may be employed without departing from the principles described herein, wherein:

FIG. 1 is a block diagram of an exemplary embodiment of a system that enables sellers with multiple product sale transactions through an online retail logistic provider to manage growth capital according to the present disclosure, illustrating a predictive service in communication with a seller, an investor and multiple data sources;

FIG. 2 is a block diagram of an exemplary embodiment of an exemplary embodiment of the predictive service of FIG. 1; and

FIG. 3 is an exemplary flow diagram for the method predicting future seller inventory value for determining qualified capital contributions.

### DETAILED DESCRIPTION

The present disclosure provides a predictive system and method that enables sellers who sell products through an online retail logistic provider to manage growth capital by predicting in real-time and on a rolling basis a monetary value of the seller's future sales of product being sold by the online retail logistic provider, and then calculating a qualified capital contribution for an investor to make to the seller. The predictive system permits the seller to make real-time changes to repayment terms, capital structure and transaction decisions in their business while simultaneously providing high returns and capital protections to inventors.

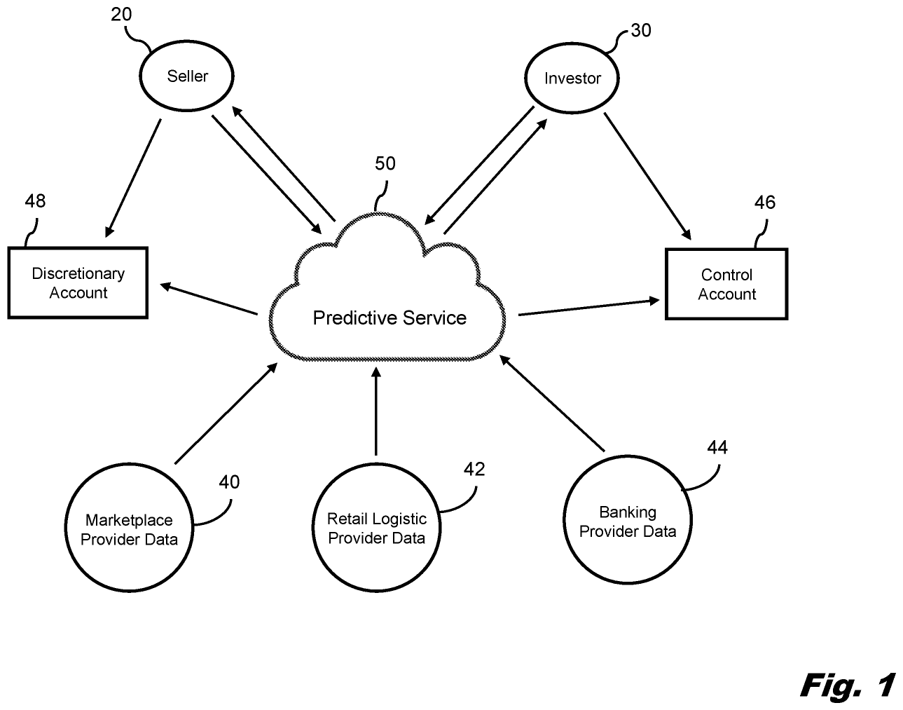

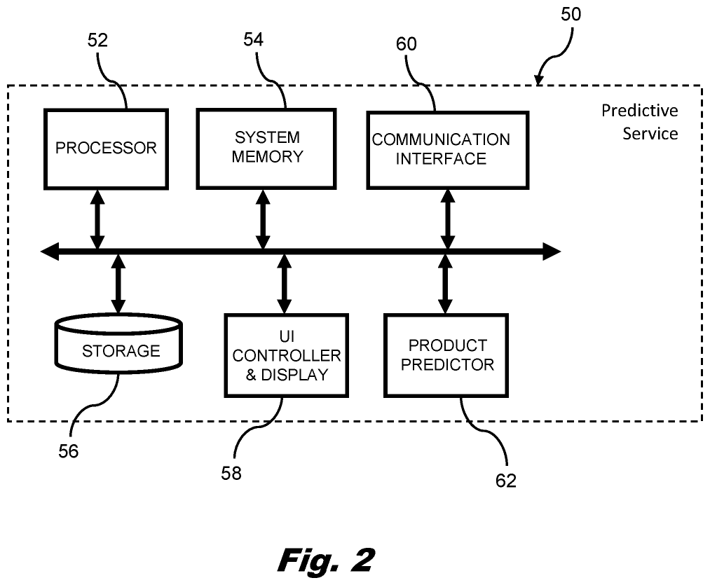

Referring to FIGS. 1 and 2, an exemplary embodiment of a system that enables sellers who sell products through an online retail logistic provider to manage growth capital according to the present disclosure is shown. A system 10 that enables sellers who sell products through an online retail logistic provider to manage growth capital may also be referred to herein as the “system.” The sellers contemplated by the present disclosure include early stage companies and other companies who sell one or more products through an online retail logistic provider. Online retail logistic providers contemplated include companies, such as e-commerce technology company Amazon.com, Inc. and other platforms that allow customers to shop online and deliver purchased products to customers.

The system 10 connects sellers 20 of products and investors 30 using a predictive service 50. Data for the system 10 is retrieved from various sources, including one or more marketplace data providers 40, retail logistic providers 42, and one or more banking providers 44. The marketplace data providers include, for example, Amazon.com and Keepa.com. The marketplace data includes number of units of products sold, prices per unit and number of sellers selling the products. The data available from the retail logistic provider 42 includes for each seller, the seller's inventory on hand, the seller's inventory in transit, locations of the seller's inventory, and order and payment histories of the seller's products sold by the retail logistic provider 42. The banking providers 44 stores capital contributions by the investor 30, capital for product inventory purchases and sales proceeds paid by the retail logistic provider 42 in a control account 46. The control account 46 is controlled by the investor 30. The banking data 44 also stores operating capital in a discretionary account 48 for the seller 20 to use to pay discretionary corporate expenses. The discretionary account 48 is controlled by the seller 20.

The predictive service 50 includes a processor 52 that executes software instructions or code stored in, for example, system memory 54, e.g., random access memory, or on a storage device 56, and/or in a product predictor 62 to perform the method and service disclosed herein. Alternately, with in-memory computing devices or systems, the system memory 54 would have sufficient storage capacity to store much if not all of the data and program instructions used for the running the predictive service, instead of storing the data and program instructions in the storage device 56. Further, the stored instructions may be further compiled to generate other representations of the instructions and dynamically stored in the system memory 54. In either embodiment, the processor 52 reads instructions from the storage device 56 or system memory 54 and/or the product predictor 62, and performs actions as instructed. The storage device 56 also provides storage space for retaining information about the seller and seller product information. Non-limiting examples of seller information include, the name of the seller, address of the seller, bank account details, ownership and legal entity status, authorized individuals, marketplace approvals and ratings, and approved supplier information. Non-limiting examples of seller product information include, product names, unique product identification numbers, price each product was sold at, when the products were sold and at what quantities supplied. The predictive system 50 may also include a user interface controller and display 58 to provide visual information to sellers and investors, and an input device (not shown) to permit sellers and users or other devices to enter data into and/or otherwise interact with the predictive system 50. One or more of the output or input devices could be joined by one or more additional peripheral devices to further expand the capabilities of the predictive system 50, as is known. A communication interface 60 is provided to connect the predictive system 50 to a network, such as the internet or other network, and in turn to other devices connected to the internet, including clients, servers, data stores, interfaces and mobile platforms. The predictive system 50 also includes the product predictor 62 used to predict future seller inventory values as described hereinbelow.

### Seller Interface and Functions

Referring to FIG. 1, the system 10 allows the seller 20 to manage the operations of the business including managing a series of inventory purchases, sales transactions and capital disbursements and expenditures. The seller 20 is provided access to system information via the predictive service 50. The seller 20 can determine disbursements of profit and such disbursements affect the investor profit percentage which determines how quickly the investor capital is returned.

### Investor Interface and Functions

Referring to FIG. 1, the system 10 provides the investor 30 with near real-time access to financial information through, for example, the banking data available via the banking provider 44, and provides direct control of the investor qualified capital contribution through the control account 46. The investor 30 secures and monitors the control account 46 to hold the funds to acquire inventory, to receive seller's sales proceeds from the retail logistic provider 42, and to distribute funds as required. The investor 30 also has security and control provisions over key seller 20 assets, such as inventory and account receivables received from the retail provider 42. The investor 30 gets profit participation with superior capital protection due to direct control of the release of qualified capital contribution funds and real time transparency and priority of capital with low profit-share capital percentage. The investor 30 has the authority to intervene in the transaction process based on predetermined parameters, such as size of orders requested by the seller, specific product categories being purchased customers from the retail logistic provider 42, low expected profit margin of products being sold via the retail logistic provider, excessive distributions by the seller, or incremental results, such as inadequate recent profit or sales volume of one or more products being sold by the seller 20 via the retail logistic provider.

### Inventory Classification

With the system 10 according to the present disclosure, seller 20 products sold by the retail logistic provider 42 are classified so that only certain product data is included in an accepted seller product inventory. In an exemplary embodiment, the seller 20 products sold by the retail logistic provider 42 may be classified into one of four categories; unacceptable, deferred, low profitability or profitable. Unacceptable products are products that are not approved by the retail logistic provider for sale on their platform. Deferred products are products that are projected to sell at a point in time beyond a predetermined time period, e.g., more than 90 days, in the future. Low profitability products are products with a profit margin below a predefined percentage, e.g., a profit margin of 10 percent or less, or products with a monthly return on investment of less than 10 percent. Data for unacceptable products are excluded from use in an investment product p[ool processed by the system 10. Data for deferred products may be added to subsequent seller product data sets processed by the system 10 depending upon, for example, when the deferred seller products are projected to sell and the predetermined time period. For example, seller product data for deferred products are expected to be added into the seller product data set processed by the system 10 when sales of such products are predicted by the product predictor 62 to occur within the predetermined time period, e.g., within 90 days.

### Predictive Model

The product predictor 62 is configured to predict in real-time and on a rolling basis the seller's future monthly product sales over a predefined period of time and the pricing of all of the seller's monthly product inventory to be sold over the predefined period of time and stored in the system 10. As a non-limiting example, the predefined period of time to predict the seller's future product sales and the pricing of all seller's product inventory is about three months.

The product predictor 62 uses the seller's historical data and/or marketplace historical data retrieved from the retail logistic provider and the market data provider 42 and stored in the storage device 56 to predict future sales and pricing of all of seller's accepted products to be sold by the retail logistic provider 42. More specifically, the product predictor 62 generates on a product-by-product basis a monthly prediction of the sales volume and price for each accepted product to be sold each month over the predetermined period of time. It is noted that a unique product indicator can be used to differentiate between seller's products. The product predictor 62 generates a monthly prediction of the sales volume and price for each accepted product. The monthly product sales are typically reduced by expenses including fees charged by the retail logistic provided 42.

The monthly sales are predicted based on, for example, previous sales by the seller of the product. The product predictor 62 performs an analysis that evaluates past sales of the seller's products and projects forward for a predetermined period of time, e.g., three months. The product predictor 62 may also use additional data when making the prediction. For example, the product predictor 62 may include marketplace data that is not seller specific. Examples of such marketplace data includes, Amazon.com data or Keepa.com data.

The analysis performed may be one of a number of different analysis, for example, a time series model analysis, a statistical analysis or other analytical methods to predict future sales of products. An example of a suitable time series model may be the auto regressive integrated moving average (ARIMA time series model). This prediction model uses historical seller product data to analyze trends in sales (auto regression) of seller products, and the moving average considers factors, such as seasonality in the seller products, product category, average price for the product and other available data, to provide a refined sales prediction value.

Another exemplary embodiment of a prediction model uses a number of reviews a seller product has received on the retail logistic provider e-commerce platform, e.g., Amazon.com's platform, a predefined coefficient, e.g., a coefficient of 5, and a number of qualified sellers of the product on the retail logistic provider e-commerce platform as an input to the below formula.

sales prediction of a product per seller=((no. of reviews received by the seller's product on the retail logistic provider e-commerce platform in the last 90 days)×(coefficient))/(no. of qualified sellers on the retail logistic provider e-commerce platform)

The product pricing is determined by taking an average of the product pricing over a previous three month period. The historical product pricing can be retrieved from the retail logistic provider or other provider such as Keepa.com.

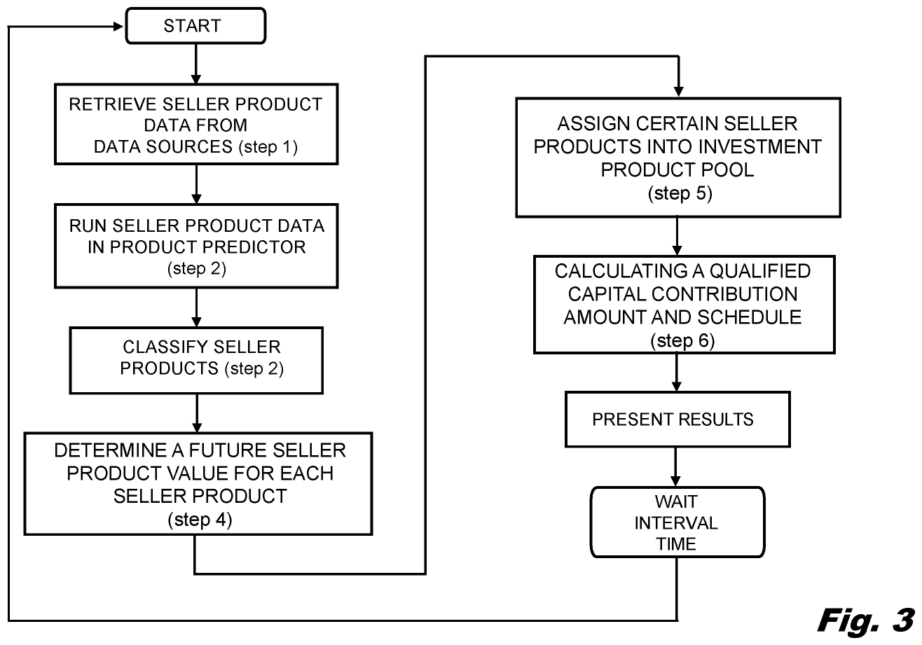

Referring to FIG. 3, an exemplary flow diagram for predicting a future seller product value for determining qualified capital contributions at predetermined points in time is shown. Initially, the system 10 retrieves current, real-time seller information and all seller product data stored in the retail logistic provider 42 database, and possibly other provider databases, such as the marketplace provider 40 databases (step 1). As set forth above, the seller information may include, for example, the name of the seller, address of the seller, bank account details, ownership and legal entity status, authorized individuals, marketplace approvals and ratings, and approved supplier information, and the seller product data may include, product names, unique product identification numbers, price each product was sold at, when the products were sold and at what quantities supplied.

With the system 10 populated with current, real-time seller product data, the product predictor 62 predicts future monthly product sales and pricing of each seller product within the accepted product inventory over the predefined time period, as described above (step 2). In this exemplary embodiment, the predefined time period is ninety days. The seller product data is then classified so that each seller product in the seller product data is placed into one or more categories to determine seller products that are to be included in an accepted product inventory (step 3). As set forth above, the seller products can be classified into, for example, one of four categories; unacceptable, deferred, low profitability or profitable. With the predicted monthly product sales and pricing for each seller product within the accepted seller product inventory, the system 10 determines a future seller product value for each seller product in the accepted seller product inventory over the predetermined time period (step 4). The future seller product value may be a net present monetary value of the future sales of each seller product based upon the predicted monthly product sales and predicted pricing of each seller product. With the predicted monthly product sales and pricing for each seller product within the accepted seller product inventory, the system 10 assigns one or more of the seller products in the accepted seller product inventory into an investment product pool(step 5). The one or more of the seller products to be assigned to the investment product pool must result in an investment product pool having an overall net present value that is greater than or equal to zero. For example, the one or more of the seller products to be assigned to the investment product pool may include one or more of the seller products classified as profitable and one or more of the seller products classified as low profitable. As another example, the one or more of the seller products to be assigned to the investment product pool may include all seller products classified as profitable and one or more of the seller products classified as low profitable. As another example, the one or more of the seller products to be assigned to the investment product pool may include one or more of the seller products classified as profitable and no seller products classified as low profitable.

The system 10 then calculates a qualified capital contribution amount for the seller (step 6). The qualified capital contribution amount is a monetary sum that the investor makes available to the seller via the control account 46. The qualified capital contribution amount is calculated based upon a sum of the future seller product value for each accepted seller product. The qualified capital contribution amount may be disbursed in one of a variety of disbursement processes. For example, for qualified capital contribution amount of $120,000, the funds can be distributed as follows:

1) 5,000 in month one on approved inventory;

2) $5000 in month two on approved inventory;

3) 10,000 in month three on transitional inventory; and

4) $100,000 based on profit reinvestment over 12 months.

The system 10 then waits a defined time period, e.g., once a month, and then repeats the steps 1-6 to calculate the qualified capital contribution amount for the next period.

Using the system and method according to the present disclosure, an investor secures a profit share based on an agreed formula and the investor monitors and controls certain funds until the investor's profit share percentage fully dissipates. The system according to the present disclosure links marketplace data with banking and accounting systems so that all parties have transparency. Marketplace data is used to validate and classify asset value and to evaluate transactional decisions made by the owner Incremental and micro transaction results are monitored and used to reassess and adjust going forward parameters. The banking and accounting links permit the investor to protect their capital investment and permit transparency to facilitate and improve owner decision making.

The product predictor 62 allows a seller to determine and adjust the capital structure and thus the relative investor profit percentage in the business. Transactions are processed via data feed or input in near real-time. Investor profit share percentages and capital investment re-apportionment are processed in near real-time and readjusted at predetermined intervals (such as monthly).

Using the predictive system and method according to the present disclosure, apportioned but undistributed profits are accrued to the investor and categorized as accrued capital with a senior priority status protected by direct investor asset control. This permits the investor to recover, if required, its capital and any investment returns without relying on conventional investment recovery processes.

While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A method for predicting a future seller product value for determining inventor capital contributions at desired points in time, the method comprising:
retrieving seller information and seller product data from a retail logistic provider database;
predicting future product sales and pricing of each seller product within the retrieved seller product data over a predefined time period;
classifying each seller product in the seller product data into one or more categories to determine an accepted seller product inventory;
determining a future seller product value for each seller product in the accepted seller product inventory over the predetermined time period;
assigning one or more seller products in the accepted seller product inventory into an investment product pool;
calculating a qualified capital contribution amount and schedule for the seller based upon the future seller product inventory value for each seller product in the investment product pool over the predetermined time period.
